(19) United States
(12) Patent Application Publication
(10) Pub. No.: US 2014/0023800 A1
(43) Pub. Date: Jan. 23, 2014

(54) Sports Logo Flag and Article of Manufacture with Sports Logo Flag Image

(71) Applicant: Peter Webster, Corning, NY (US)

(72) Inventor: Peter Webster, Corning, NY (US)

(21) Appl. No.: 13/944,231

(22) Filed: Jul. 17, 2013

Related U.S. Application Data
(60) Provisional application No. 61/673,887, filed on Jul. 20, 2012.

(51) Int. Cl. G09F 17/00

(52) U.S. Cl. CPC G09F 17/00
USPC 428/28; 428/195.1

(57) ABSTRACT

A flag or a flag image includes at least one sports logo in the union portion of an American flag or an American flag image without the conventional stars in the union portion. The flag image may be located on any article of manufacture. In some embodiments, fifty copies of the same sports logo replace the fifty stars. In other embodiments, a single copy of the sports logo appears in the union portion. In some embodiments, the sports logo is a sports team logo. In some embodiments, one or more colors associated with the sports team represented by the sports team logo replace one or more of the red, white, and blue colors of a conventional American flag.

### REFERENCE TO RELATED APPLICATIONS

This application claims one or more inventions which were disclosed in Provisional Application No. 61/673,887, filed Jul. 20, 2012, entitled “SPORTS LOGO FLAG AND ARTICLE OF MANUFACTURE WITH SPORTS LOGO FLAG IMAGE”. The benefit under 35 USC §119(e) of the U.S. provisional application is hereby claimed, and the aforementioned application is hereby incorporated herein by reference.

### BACKGROUND OF THE INVENTION

1. Field of the Invention

The invention pertains to the field of articles of manufacture. More particularly, the invention pertains to articles of manufacture with a sports team logo.

2. Description of Related Art

The American flag has a substantially rectangular shape with conventional proportions. A conventional American flag has a length that is 1.9 times the width. The rectangular union in the upper left corner has a width that is 7/13^{th} the width of the flag and a length that is 0.76 times the width of the flag. The non-union portion of the flag has thirteen horizontal stripes of equal width, alternating red and white in color, with the first and last colors being red. The union portion is blue with fifty white stars arranged as five rows of six alternating with four rows of five and offset to also form six columns of five alternating with five columns of four with equal spacing between the row and equal spacing between the columns. The diameter of each star is 0.0616 times the width of the flag.

Alterations of the conventional American flag design are known in the art.

### SUMMARY OF THE INVENTION

A flag or a flag image includes at least one sports logo in the union portion of an American flag or an American flag image without the conventional stars in the union portion. The flag image may be located on any article of manufacture. In some embodiments, fifty copies of the same sports logo replace the fifty stars. In other embodiments, copies of different sports logos replace the stars. In this embodiment, there may be fifty or less than fifty different sports logos in the union section of the flag or flag image. In other embodiments, a single copy of the sports logo appears in the union portion. In some embodiments, the sports logo is a sports team logo. In some embodiments, one or more colors associated with the sports team represented by the sports team logo replace one or more of the red, white, and blue colors of a conventional American flag.

### BRIEF DESCRIPTION OF THE DRAWINGS

FIG. 1a shows the front side of a flag in an embodiment of the present invention.

FIG. 1b shows the back side of the flag of FIG. 1a.

FIG. 1c shows an example of a sports team logo.

FIG. 1d shows another example of a sports team logo.

FIG. 2 shows a front side of a flag in an embodiment of the present invention.

FIG. 3 shows a front side of a blanket in an embodiment of the present invention.

### DETAILED DESCRIPTION OF THE INVENTION

In some embodiments, a flag includes at least one sports logo. In some embodiments, the flag is an American flag with a copy of the sports logo replacing each of the fifty stars in the flag. In one preferred embodiment, the same sports logo replaces each of the fifty stars. In another preferred embodiment, up to fifty copies of the same sports logo are located in the union section of the flag. In another embodiment, up to fifty different sports logos are located in the union section of the flag. For example, the union section of the flag may include a sports team logo for each of the teams in a professional sports league. As another example, the union section of the flag may include sports league logos for a number of different sports leagues. As another example, the union section of the flag may include a sports team logo for each of the teams in a sports tournament (for example, the sixty four teams in the NCAA college basketball tournament). In other embodiments, the flag is an American flag without the stars in the union portion of the flag and a single sports logo in the union portion. In other embodiments, the union portion includes another predetermined number of copies of the same or different sports logos.

In some embodiments, the flag is a flag image located on an article of manufacture. The article of manufacture may include, but is not limited to, a framed print, a blanket, a sleeping bag, a curtain, a wall hanger, clothing, head wear, a placemat, a bumper sticker, a coffee mug, a sun guard for an automobile, key chains, drink koozies, stationary, license plates, and car covers. The flag image may cover the entire surface of one or both sides of the article of manufacture or may cover only a portion of one or both sides or surfaces of the article. If the flag image covers only a portion of a surface or a side of the article, the article may include multiple copies of the flag image.

The resulting flag or article of manufacture reflects both the patriotism of the owner and their support for a sports league, a division of a sports league, or a sports team represented by the sports logo.

A sports logo, as used herein, may be any two-dimensional design or image that represents a sports league, a division of a sports league, or a sports team. A sports team logo, as used herein, may be any two-dimensional design or image that represents a sports team.

In some embodiments, the sports logo is a sports team logo of a professional sports team. In some embodiments, the professional sports team is an American sports team. In other embodiments, the professional sports team is a non-American sports team. In some embodiments, the professional sports team is a current professional sports team. In some embodiments, the sports team logo is a currently used logo of a current professional sports team. In other embodiments, the sports team logo is a previously-used logo of a current professional sports team. In other embodiments, the professional sports team is a former professional sports team that has changed locations, no longer exists, or has changed names.

In some embodiments, the professional sports team is a current Major League Baseball® team. In some embodiments, the current Major League Baseball® team is the Arizona Diamondbacks, the Atlanta Braves, the Baltimore Orioles, the Boston Red Sox, the Chicago Cubs, the Chicago White Sox, the Cincinnati Reds, the Cleveland Indians, the Colorado Rockies, the Detroit Tigers, the Houston Astros, the Kansas City Royals, the Los Angeles Angels, the Los Angeles Dodgers, the Miami Marlins, the Milwaukee Brewers, the Minnesota Twins, the New York Mets, the New York Yankees, the Oakland Athletics, the Philadelphia Phillies, the Pittsburgh Pirates, the Saint Louis Cardinals, the San Diego Padres, the San Francisco Giants, the Seattle Mariners, the Tampa Bay Rays, the Texas Rangers, the Toronto Blue Jays, or the Washington Nationals.

In other embodiments, the professional sports team is a current National Football League® team. In some embodiments, the current National Football League® team is the Arizona Cardinals, the Atlanta Falcons, the Baltimore Ravens, the Buffalo Bills, the Carolina Panthers, the Chicago Bears, the Cincinnati Bengals, the Cleveland Browns, the Dallas Cowboys, the Denver Broncos, the Detroit Lions, the Green Bay Packers, the Houston Texans, the Indianapolis Colts, the Jacksonville Jaguars, the Kansas City Chiefs, the Miami Dolphins, the Minnesota Vikings, the New England Patriots, the New Orleans Saints, the New York Giants, the New York Jets, the Oakland Raiders, the Philadelphia Eagles, the Pittsburgh Steelers, the Saint Louis Rams, the San Diego Chargers, the San Francisco 49ers, the Seattle Seahawks, the Tampa Bay Buccaneers, the Tennessee Titans, or the Washington Redskins.

In other embodiments, the professional sports team is a current National Basketball Association team. In some embodiments, the current National Basketball Association team is the Atlanta Hawks, the Boston Celtics, the Charlotte Bobcats, the Chicago Bulls, the Cleveland Cavaliers, the Dallas Mavericks, the Denver Nuggets, the Detroit Pistons, the Golden State Warriors, the Houston Rockets, the Indiana Pacers, the Los Angeles Clippers, the Los Angeles Lakers, the Memphis Grizzlies, the Miami Heat, the Milwaukee Bucks, the Minnesota Timberwolves, the New Orleans Hornets, the New Jersey Nets, the New York Knicks, the Oklahoma City Thunder, the Orlando Magic, the Philadelphia 76ers, the Phoenix Suns, the Portland Trail Blazers, the Sacramento Kings, the San Antonio Spurs, the Toronto Raptors, the Utah Jazz, or the Washington Wizards.

In other embodiments, the professional sports team is a current National Hockey League team. In some embodiments, the current National Hockey League team is the Anaheim Ducks, the Boston Bruins, the Buffalo Sabres, the Calgary Flames, the Carolina Hurricanes, the Chicago Black Hawks, the Colorado Avalanche, the Columbus Blue Jackets, the Dallas Stars, the Detroit Red Wings, the Edmonton Oilers, the Florida Panthers, the Los Angeles Kings, the Minnesota Wild, the Montreal Canadiens, the Nashville Predators, the New Jersey Devils, the New York Islanders, the New York Rangers, the Ottawa Senators, the Philadelphia Flyers, the Phoenix Coyotes, the Pittsburgh Penguins, the Saint Louis Blues, the San Jose Sharks, the Tampa Bay Lightning, the Toronto Maple Leafs, the Vancouver Canucks, the Washington Capitals, or the Winnipeg Jets.

In other embodiments, the professional sports team is a current Major League Soccer® (MLS) team. In some embodiments, the current Major League Soccer team is the Chicago Fire, the Civas USA, the Colorado Rapids, the Columbus Crew, the D.C. United, the FC Dallas, the Houston Dynamo, the Los Angeles Galaxy, the New England Revolution, the New York Red Bulls, the Philadelphia Union, the Portland Timbers, the Real Salt Lake, the San Jose Earthquakes, the Seattle Sounders FC, or the Sporting Kansas City.

In another embodiment, the sports logo is for a NASCAR driver. In this embodiment, the flag includes a driver's number in the color coordination it is on his or her car. In other embodiments, the team is a semi-professional or a minor league team.

In other embodiments, the team is a college sports team. In some embodiments, the sports team logo is a general logo for all sports teams of the college or university. In other embodiments, the sports team logo is a logo for a specific sports team at the college or university. In some embodiments, the sports team is National Collegiate Athletic Association Division I football team. In other embodiments, the sports team is National Collegiate Athletic Association Division I basketball team.

In other embodiments, the sports logo is for a league, a conference, a division, a tournament or another sports competition.

In some embodiments, the sports logo is selected from the sports logos included in John Fulgaro's Sports Logo Guide: Third Edition, by John Fulgaro, Sports Fanatic, 1997, incorporated by reference herein. In some embodiments, the sports logo is selected from the sports logos included at www.sportslogos.net, incorporated by reference herein.

In some embodiments, the flag or flag image has the conventional thirteen alternating red and white stripes and blue union background of an American flag. In some embodiments, the sports logo is a single color. In some embodiments, the single color is white. In other embodiments, the sports logo is multiple colors. In other embodiments, one or more of the conventional red, white, and blue colors are substituted with one or more colors representative of the sports team represented by the sports team logo. In one embodiment, a Miami Dolphins flag has at least one Miami Dolphins team logo and includes thirteen alternating orange and white stripes and an aqua-colored union background.

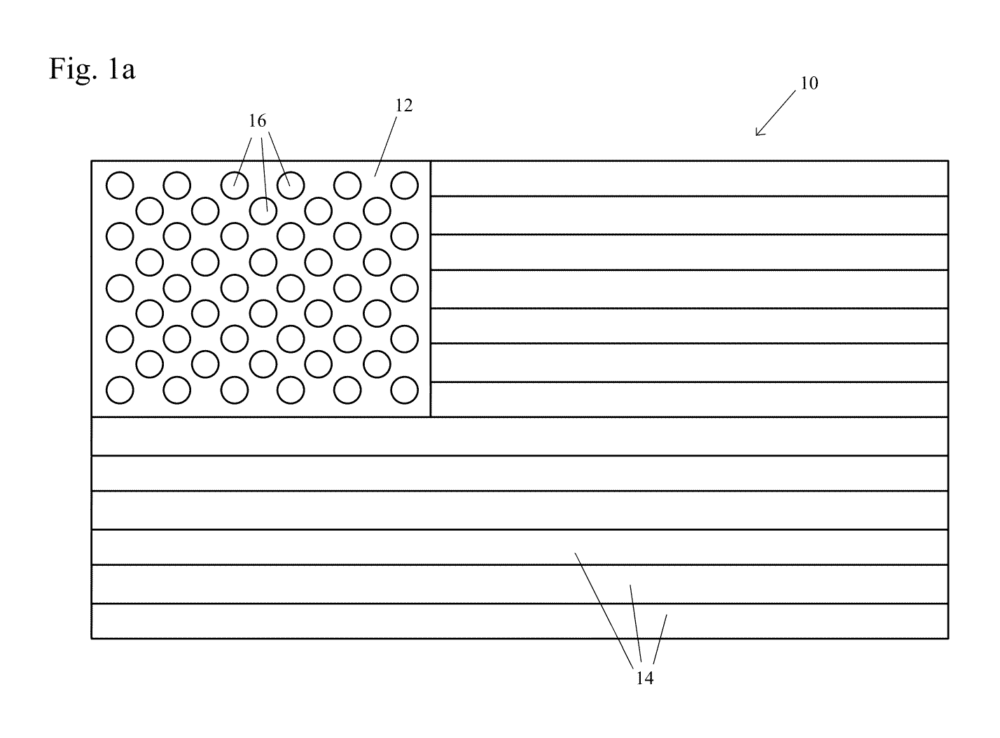

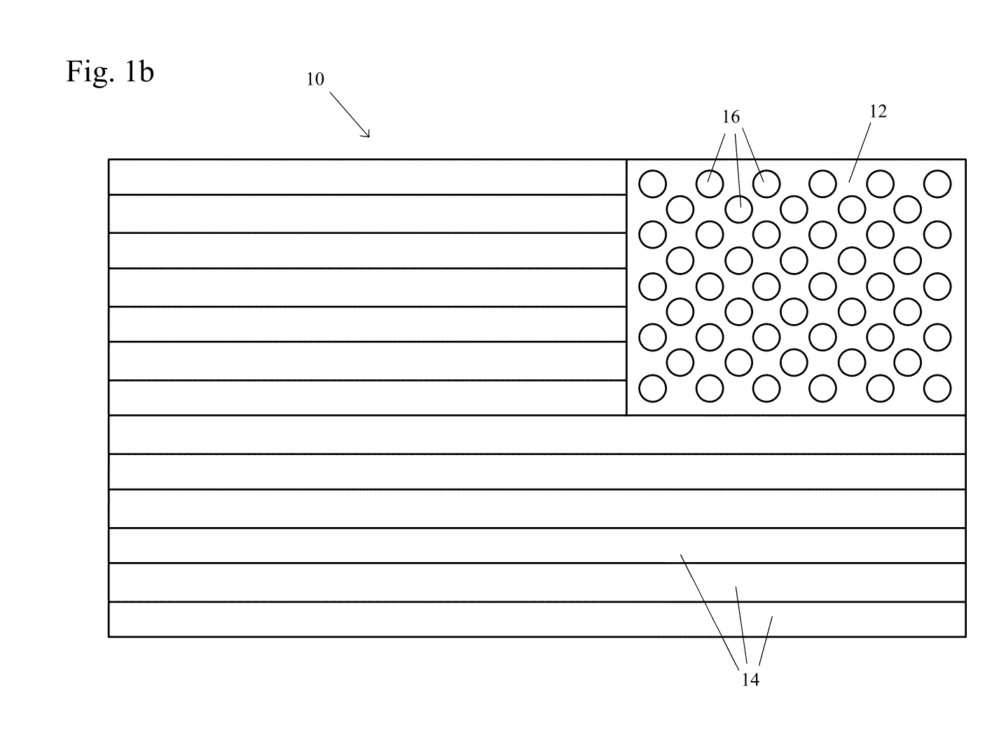

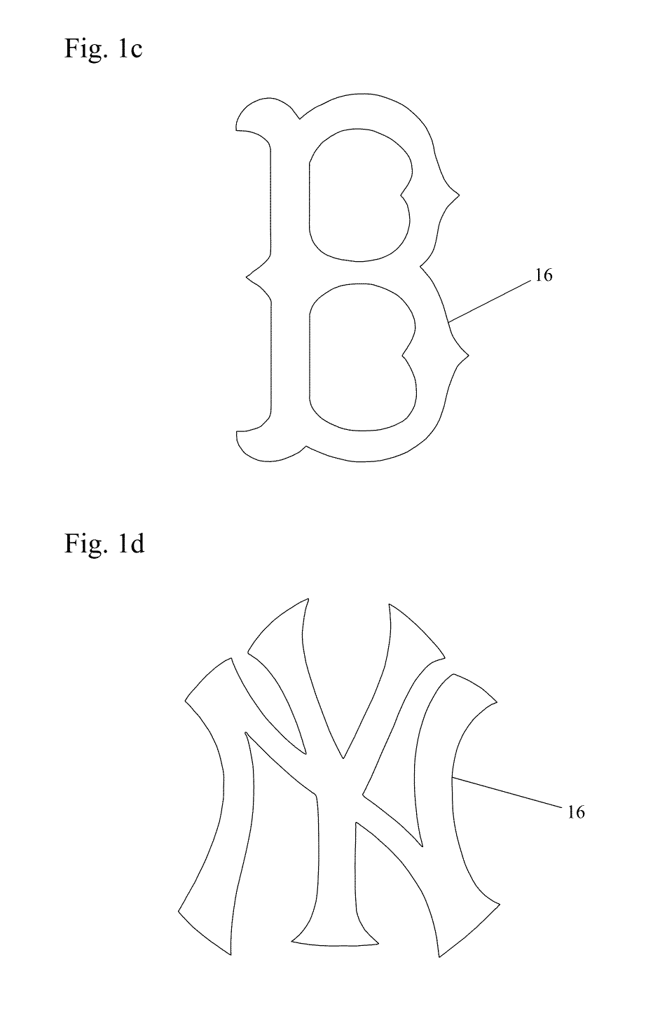

FIG. 1a and FIG. 1b show the front and back sides of a flag 10, respectively. The flag 10 has a rectangular shape with a union 12 in the upper right front and upper right back of the flag. Thirteen stripes 14 fill the rest of the flag area. These figures show fifty sports logos 16 in the same configuration on the flag as the fifty stars in a conventional American flag, but there may be any number of sports logos in the union portion of the flag within the spirit of the present invention. In one preferred embodiment, the sports logos 16 are all copies of the same sports logo. In another preferred embodiment, each sport logo is a different sports logo. In some of these embodiments, the sports logos represent some or all of the sports teams in a division, conference, or league. In other embodiments, the sports logos represent sports teams from different divisions, conferences, leagues, or sports. In one embodiment, the sports logos represent all of the owners favorite teams in different sports, which may include professional, semi-professional, minor league, or college sports teams.

Each sports logo 16 is represented as a circle in FIG. 1a and FIG. 1b but may have any shape or design. Examples of sports logos are shown in FIG. 1c and FIG. 1d. FIG. 1c shows a sport teams logo for the Boston Red Sox. FIG. 1d shows a sports team logo for the New York Yankees. The logos shown in FIGS. 1c and 1d are registered trademarks of the Boston Red Sox Baseball Club and the New York Yankees Partnership, respectively. The stripes 14 may be the colors of a conventional American flag, or the colors of the sports team, division, conference, or league that is represented by the sports logos 16 on the union 12.

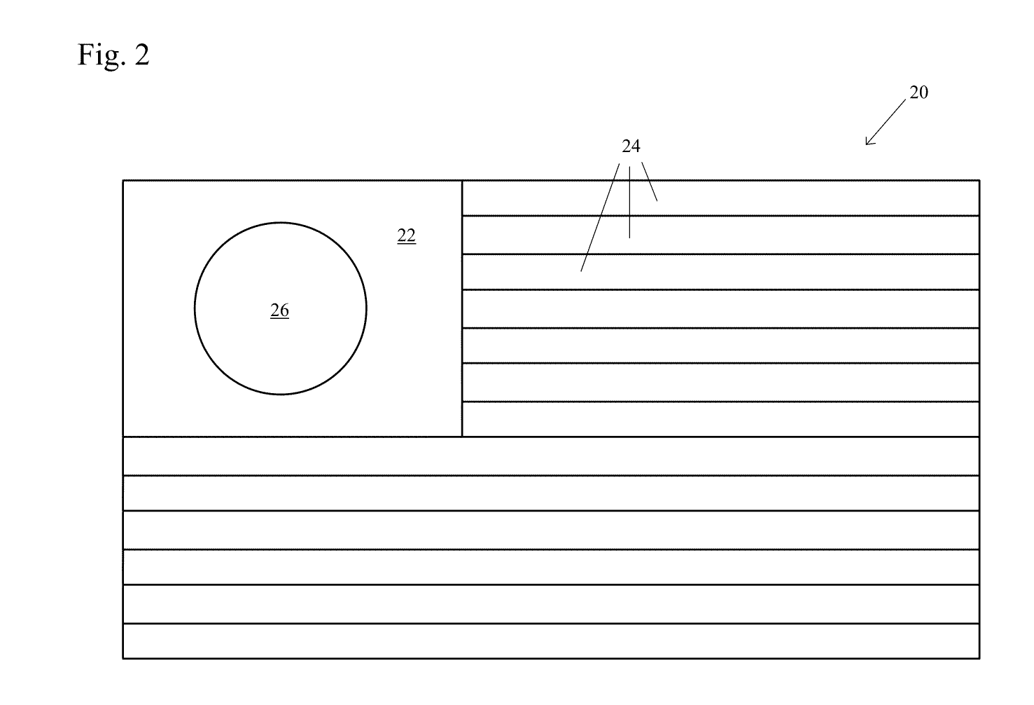

FIG. 2 shows the front side of a flag 20 with thirteen stripes 24 and a single sports logo 26 in the union 22. The stripes 24 may be the colors of a conventional American flag, or the colors of the sports team, division, conference or league that is represented by the sports logo 26 in the union 22.

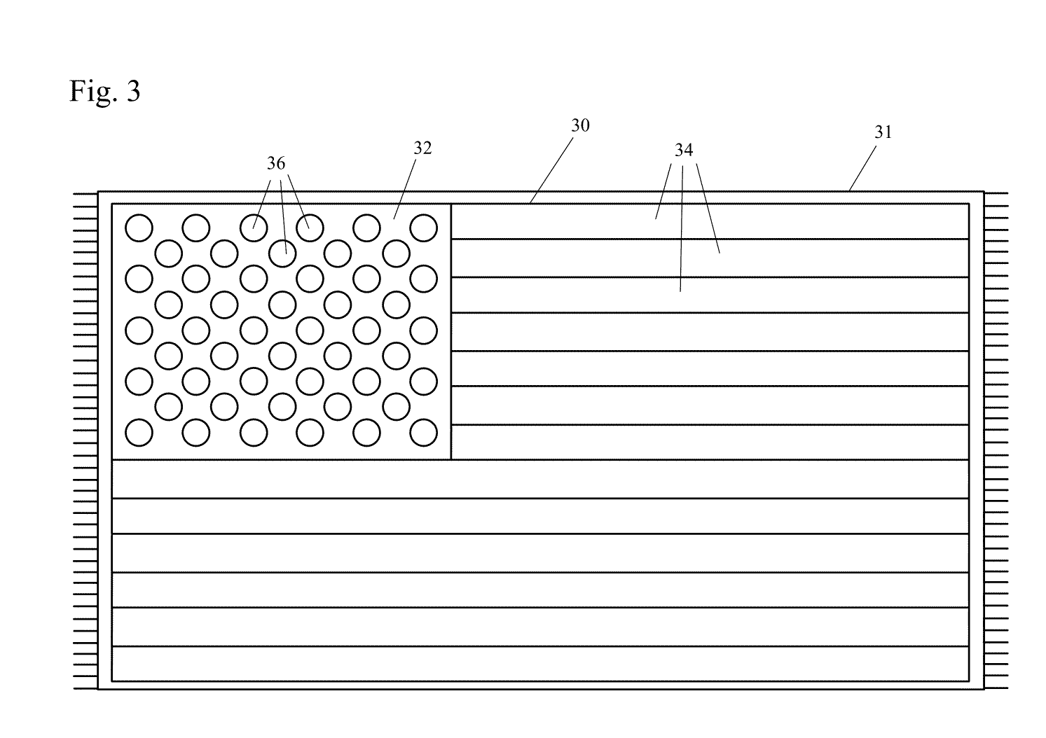

FIG. 3 shows a flag image 30 on an article of manufacture 31, in this case a blanket. The flag image 30 covers almost the entire side of the blanket. The flag image 30 includes thirteen stripes 34 and fifty sports logos 36, which may be the same sports logos or different sports logos, in the same configuration on the flag image as the fifty stars in a conventional American flag, similar to what is shown in FIG. 1a and FIG. 1b, in the union 32. The stripes 34 may be the colors of a conventional American flag, or the colors of the sports team, division, conference, or league that is represented by the sports logos 36 in the union 32. While fifty sports logos 36 are shown in this figure, in alternative embodiments, the union 32 includes one single sports logo 26. In one preferred embodiment with multiple copies of a sports logo 36 in the union 32, the sports logos 36 are all the same sports logo. In another preferred embodiment, each sport logo is a different sports logo. In other embodiments, there are multiple copies of the sports logo 36 (but not fifty) in the union section of the flag image 30. The flag image 30 may be located on just one side or both sides of the blanket. In alternative embodiments, multiple flag images 30 may included on a single article of manufacture, such as a blanket.

The flag image 30 may be formed as part of the blanket material or may be formed by dying the image into the blanket material or applying the image to the surface of the blanket.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

1. A flag having a rectangular shape and having a first side comprising:
a union portion having a rectangular shape and located in an upper left portion of the first side; and
a stripe portion comprising a plurality of horizontal stripes, the stripe portion contacting a right edge and a bottom edge of the union portion and being located in an upper right portion and a lower portion of the first side;
wherein the union portion comprises a plurality of copies of a sports logo.

2. The flag of claim 1, wherein the sports logo is a sports team logo.

3. The flag of claim 2, wherein the sports team logo represents a professional sports team.

4. The flag of claim 3, wherein the professional sports team is a team selected from the group consisting of a Major League Baseball® team, a National Football League team, a National Basketball Association team, and a National Hockey League team.

5. The flag of claim 2, wherein the sports team logo represents a college sports team.

6. The flag of claim 2, wherein the stripe portion comprises thirteen horizontal stripes of two alternating colors and the two alternating colors represent a sports team represented by the sports team logo.

7. (canceled)

8. The flag of claim 1, wherein the union portion comprises fifty copies of the sports logo.

9. An article of manufacture having at least one surface comprising a flag image having a rectangular shape and comprising:
a union portion having a rectangular shape and located in an upper left portion of the flag image; and
a stripe portion comprising a plurality of horizontal stripes, the stripe portion contacting a right edge and a bottom edge of the union portion and being located in an upper right portion and a lower portion of the flag image;
wherein the union portion comprises a plurality of copies of a sports logo.

10. The article of manufacture of claim 9, wherein the sports logo is a sports team logo.

11. The article of manufacture of claim 10, wherein the sports team logo represents a professional sports team.

12. The article of manufacture of claim 11, wherein the professional sports team is a team selected from the group consisting of a Major League Baseball® team, a National Football League team, a National Basketball Association team, and a National Hockey League team.

13. The article of manufacture of claim 10, wherein the sports team logo represents a college sports team.

14. The article of manufacture of claim 10, wherein the stripe portion comprises thirteen horizontal stripes of two alternating colors and the two alternating colors represent a sports team represented by the sports team logo.

15. (canceled)

16. The article of manufacture of claim 9, wherein the union portion comprises fifty copies of the sports logo.

17. An article of manufacture having at least one surface comprising a flag image having a rectangular shape and comprising:
a union portion having a rectangular shape and located in an upper left portion of the flag image; and
a stripe portion comprising a plurality of horizontal stripes, the stripe portion contacting a right edge and a bottom edge of the union portion and being located in an upper right portion and a lower portion of the flag image;
wherein the union portion comprises fifty copies of a single sports logo.
